(19) United States
(12) Patent Application Publication
(10) Pub. No.: US 2019/0393666 A1
(43) Pub. Date: Dec. 26, 2019

(54) TERMINAL WITH CURVED PART ASSEMBLY DEVICE

(71) Applicant: DONGGUAN UNIVERSITY OF TECHNOLOGY, Dongguan (CN)

(72) Inventors: JUN DENG, Dongguan (CN); Chuliang He, Dongguan (CN)

(21) Appl. No.: 16/442,468

(22) Filed: Jun. 15, 2019

(30) Foreign Application Priority Data
Jun. 22, 2018 (CN) CN2018106489363

(51) Int. Cl. H01R 43/20; H01R 13/22

(52) U.S. Cl. CPC H01R 43/20; H01R 13/22

(57) ABSTRACT

The present invention involves a terminal with curved part assembly device, comprising a frame 1, power distribution control box, turntable 3 and turntable drive device disposed on the frame 1 and matching with each other, wherein the upper edge of the turntable 3 is evenly disposed with jig assemblies 9; the jig assembly 9 comprises a jig base 11 disposed on the edge of the turntable 3; the jig base 11 is provided with a socket positioning seat 13 which matches the terminal socket 10 by plugging and fitting; the socket positioning seat 13 is internally provided with jacks 14, which match terminals 17 in the terminal socket 10 by plugging; under the jig base 11 to the left and right side of the socket positioning seat 13 are provided the upper unloading jogging poles 15, and on the said upper unloading jogging poles 15 inside the jig base 11 are provided relocating springs 19; and inside the socket positioning seat 13 are plugged terminal detection rods 16 corresponding to the jacks 14, and on the terminal detection rods 16 inside the jig base 11 are sleeved the relocating springs 19; on the periphery of the turntable 3 and on the frame 1 is sequentially provided with a socket press-in device 4, a first terminal feeding mechanism 5, a second terminal feeding mechanism 6 and a defective product reclaiming device 7, cooperating with the jig assembly 9. The present invention provides an automatic terminal fitting device, which can be applied in the technical field of automatic assembly, is able to plug the terminals into the terminal socket quickly, precisely and stably, and achieve a high quality and efficiency assembly of the connectors.

### FIELD OF THE INVENTION

The present invention relates generally to assembly devices, and more particularly to a terminal with a curved part assembly device.

### BACKGROUND OF THE INVENTION

As an electrical connection part, the terminal is small in size and relatively precise in structure, and may deform upon exertion of a slight external force. Terminal plays a very important role on electrical connection, once the terminals are connected improperly, the entire electrical system cannot run smoothly. Moreover, once the electrical system runs out of order due to the improperly connected terminals, it is necessary to carry out inspection to the entire electrical system to detect the terminals in question, which wastes a lot of time and effort.

There is a new four-pin connector with four sets of terminals 17 inserted inside side by side, the structure of which is shown in FIG. 17, and the upper end of the terminal 17 is provided with a curved part 18. Therefore, the connection quality of the terminals shall be guaranteed when mounting the terminals, and avoids deformation of the terminals as a result of external force. To this end, it is necessary to have a terminal feeding mechanism that can promise the quality of the terminals, and ensure the terminals are of good quality before connecting to electrical components such as wires. At present, the assembly of connectors is mainly done manually, the assembly work is completed by workers, and the drawbacks of the above mode of assembly work are: large workload for assembly staff, low efficiency, and high error rate. In addition, a great number of manpower and equipment is to be consumed by manual operation, which causes a waste of space and money, and is difficult to promise good quality and efficiency.

### OVERALL OBJECTIVE OF THE PRESENT INVENTION

The present invention has as its overall objective the provision of an automatic terminal insertion mechanism to overcome the defects existing in the prior art for the field of automatic assembly, which may insert a terminal into a terminal socket quickly, accurately and stably, thereby achieving high-quality and high-efficiency assembly of the connector.

### SUMMARY OF THE INVENTION

In order to achieve above object, the technical solutions adopted by the invention are as follows:

A terminal with curved part assembly device, comprising a frame 1, power distribution control box, turntable 3 and turntable drive device disposed on the frame 1 and matching with each other, wherein the upper edge of the turntable 3 is evenly disposed with jig assemblies 9; the jig assembly 9 includes a jig base 11 disposed on the edge of the turntable 3; the jig base 11 is provided with a socket positioning seat 13 which matches the terminal socket 10 by plugging and fitting; the socket positioning seat 13 is internally provided with jacks 14, which match terminals 17 in the terminal socket 10 by plugging; under the jig base 11 to the left and right side of the socket positioning seat 13 are provided the upper unloading jogging poles 15, and on the said upper unloading jogging poles 15 inside the jig base 11 are provided relocating springs 19; and inside the socket positioning seat 13 are plugged terminal detection rods 16 corresponding to the jacks 14, and on the terminal detection rods 16 inside the jig base 11 are sleeved the relocating springs 19; on the periphery of the turntable 3 and on the frame 1 is sequentially provided with a socket press-in device 4, a first terminal feeding mechanism 5, a second terminal feeding mechanism 6 and a defective product reclaiming device 7, cooperating with the jig assembly 9; the socket press-in device 4, the first terminal feeding mechanism 5, the second terminal feeding mechanism 6 and the defective product reclaiming device 7 are all electronically connected to the power distribution control box.

Preferably, the socket press-in device 4 includes a press-in support 401 disposed on the frame 1, pressing cylinders 404 are disposed vertically downward on the side of the support 401 adjacent to the turntable 3; the output of the pressing cylinders 404 is respectively connected to pressing plates 403, the lower ends of the pressing plates 403 are respectively connected with socket pressing heads 402 cooperating with the terminal socket 10; the pressing cylinder 404 is electrically connected to the power distribution control box.

Preferably, both the first terminal feeding mechanism 5 and the second terminal feeding mechanism 6 include a terminal insertion support 501 and a terminal vibration feeding plate 508 disposed side by side on the frame 1, and a terminal conveying track 507 connected to the terminal vibration feeding plate 508; before terminal insertion support 501 is provided an inter-terminal distance adjusting device 502 cooperating with the terminal conveying track 507, the upper end of the terminal insertion support 501 is provided with a terminal insertion cylinder 503 vertically downward; the output of the terminal insertion cylinder 503 is connected with a terminal pressing connection plate 505 slidable against the terminal support 501; the terminal pressing connection plate 505 is provided with a terminal clamping device 506 located to the right side of the inter-terminal distance adjusting device 502, and the terminal clamping device 506 and the jig assembly 9 on the turntable 3 are vertically aligned.

Preferably, the inter-terminal distance adjusting device 502 includes an inter-terminal distance adjusting seat 511 disposed on the terminal insertion support 501; the lower end of the inter-terminal distance adjusting seat 511 is horizontally connected with an inter-terminal distance adjusting plate 512, and the bottom of the inter-terminal distance adjusting plate 512 is provided with inter-terminal distance adjusting slots 536 matching terminals 17 respectively; the distance between the inter-terminal distance adjusting slots 536 increases gradually and is finally the same as the distance between the terminal insertion holes in the product connector.

Preferably, a terminal positioning cylinder 509 is horizontally disposed on the terminal support 501 and under the inter-terminal distance adjusting seat 511; the output of the terminal positioning cylinder 509 is connected with a terminal positioning sliding seat 515, and to the right end of the terminal positioning sliding seat 515 is provided a terminal guide cylinder 516 vertically downward; the output of the terminal guide cylinder 516 is connected with a terminal distribution block 518 cooperating with the terminal conveying track 507, the upper end of terminals 17 in the terminal distribution block 518 can be sliding against the inter-terminal distance adjusting slots 536; the middle of the terminal distribution block 518 is provided with distribution slots communicating with the terminal conveying track 507, a terminal guiding baffle plate 514 is horizontally disposed on the positioning sliding seat 515; the right end surface of the terminal guiding baffle plate 514 is located above the distribution slots and is butting with the terminal conveying track 507; to the rear side of the terminal guiding baffle plate 514 is provided a terminal positioning block 517 matching with the terminals 17.

Preferably, the terminal clamping device 506 includes an L-shaped terminal clamping connection plate 519 connected to the front side of the terminal pressing connection plate 505; a clamping mounting seat 520 is connected to the terminal clamping connection plate 519, and the lower end of the clamping mounting seat 520 is vertically connected with a terminal limit connection plate 527; the lower end of the terminal limit connection plate 527 is provided with a terminal limit block 526 butting and matching with the inter-terminal distance adjusting plate 512, and the bottom of the terminal limit block 526 is provided with terminal limit slots 537 communicating with the inter-terminal distance adjusting slots 536; the right side of the clamping mounting seat 520 is provided with a limit feeding cylinder 521 along the front-rear direction, the output of the limit feeding cylinder 521 is connected with a limit feeding connection plate 522; the lower end of the limit feeding connection plate 522 is provided with a clamping feeding cylinder 523 along the left-right direction, the output of the clamping feeding cylinder 523 is connected with a clamping connection plate 524; a main terminal clamping claw 525 matching with the terminals 17 is mounted on the lower end of the clamping connection plate 524.

Preferably, the right side of the clamping mounting seat 520 is provided with a press-down positioning device aligned vertically with the jig assembly 9; the press-down positioning device includes a terminal insertion positioning seat 528 disposed on the right side of the clamping mounting seat 520, an upper positioning rod 533 is sleeved vertically onto and can be sliding against the terminal insertion positioning seat 528, the lower end of the upper positioning rod 533 is aligned with the lower positioning rod 12 disposed on the jig base 11; and a pressing sliding seat 531 is sleeved on and can be sliding against the upper positioning rod 533, the pressing sliding seat 531 is slidably cooperating with a guide slide block 530 disposed on the clamping mounting seat 520; the upper positioning rod 533 is sleeved with a positioning buffer spring 529 above the pressing sliding seat 531; the left side of the pressing sliding seat 531 is mounted with an auxiliary terminal clamping claw 534 cooperating with the main terminal clamping claw 525, the lower end of the auxiliary terminal clamping claw 534 can be buckled with the main terminal clamping claw 525.

Preferably, a terminal lower end detection device matching with the terminal detection rods 16 is disposed below the terminal clamping device 506; the terminal lower end detection device includes a terminal detection base 802 disposed on the frame 1, a terminal detection feeding cylinder 801 is vertically upward provided on the terminal detection base 802; the output of the terminal detection feeding cylinder 801 is connected with a diffuse mode photoelectric switch 803 cooperating with the terminal detection rods 16 by plugging, the diffuse mode photoelectric switch 803 is electronically connected to the displacement sensor 804 disposed on the terminal detection base 802.

Preferably, The terminal with curved part assembly device of claim 1, wherein the defective product reclaiming device 7 includes a defective product detection support 701 disposed on the frame 1; the upper end of the defective product detection support 701 is horizontally provided with a left and right sliding cylinder 702, the output of the left and right sliding cylinder 702 is connected with a left and right translation seat 703; the bottom of the left and right translation seat 703 is provided with a front and rear sliding cylinder 704, and the output of the front and rear sliding cylinder 704 is connected with a front and rear translation seat 705; an up and down sliding cylinder 706 is vertically downward provided on the front and rear translation seat 705, and the output of the up and down sliding cylinder 706 is horizontally connected with a detection connection plate 707; the right side of the detection connection plate 707 is provided with an photoelectric sensor 708 matching the upper end of the terminals 17, and the left side thereof is provided with a defective product clamping cylinder 710; the output of the defective product clamping cylinder 710 is connected with a defective product clamping claw 709 matching the terminal socket 10.

Preferably, an unloading device 2 matching the upper unloading jogging poles 15 is disposed between the defective product reclaiming device 7 and the socket press-in device 4; the unloading device 2 comprises an unloading support 201 provided on the frame 1, and the unloading support 201 is provided with an unloading cylinder 202 corresponding to the jig assembly 9; the output of the unloading cylinder 202 is connected with an unloading jogging plate 203, the upper surface of the unloading jogging plate 203 is vertically provided with a lower unloading jogging poles 204 butting and matching with the upper unloading jogging poles 15.

### BRIEF DESCRIPTION OF THE DRAWINGS

FIG. 1 is a stereoscopic structure schematic view of the present invention;

FIG. 2 is a structure schematic view of the turntable;

FIG. 3 is a stereoscopic structure schematic view of the jig assembly;

FIG. 4 is a front side cross-sectional view of the jig assembly;

FIG. 5 is a stereoscopic structure schematic view of the first terminal feeding mechanism;

FIG. 6 is a structure schematic view of the distance adjusting device;

FIG. 7 is a partial enlarged view of portion A in FIG. 6;

FIG. 8 is a structure schematic view of the clamping device;

FIG. 9 is a structure schematic view of the pressing and positioning device;

FIG. 10 is a partial enlarged view of portion B in FIG. 9;

FIG. 11 is a structure schematic view of the bottom of the inter-terminal distance adjusting plate;

FIG. 12 is a structure schematic view of the defective product reclaiming device;

FIG. 13 is a structure schematic view of the terminal lower end detection device;

FIG. 14 is a structure schematic view of the unloading device;

FIG. 15 is a structure schematic view of the socket press-in device;

FIG. 16 is a cross-sectional view of the completed connector; and

FIG. 17 is a structure schematic view of the terminal.

### REFERENCE NUMBER KEY

The drawings include the following integers:

### 1. Frame;

2. Unloading device;
201. Unloading support;
202. Unloading cylinder;
203. Unloading jogging plate;
204. Lower unloading jogging pole;

### 3. Turntable;

4. Socket press-in device;
401. Press-in support;
402. Socket pressing head;
403. Pressing plate;
404. Pressing cylinder;
5. First terminal feeding mechanism;
501. Terminal insertion support;
502. Inter-terminal distance adjusting device;
503. Terminal insertion cylinder;
505. Terminal pressing connection plate;
506. Terminal clamping device;
507. Terminal conveying track;
508. Terminal vibration feeding plate;
509. Terminal positioning cylinder;
511. Inter-terminal distance adjusting seat;
512. Inter-terminal distance adjusting plate;
513. Terminal positioning support rod;
514. Terminal guiding baffle plate;
515. Terminal positioning sliding seat;
516. Terminal guide cylinder;
517. Terminal positioning block;
518. Terminal distribution block;
519. Terminal clamping connection plate;
520. Clamping mounting seat;
521. Limit feeding cylinder;
522. Limit feeding connection plate;
523. Clamping feeding cylinder;
524. Clamping connection plate;
525. Main terminal clamping claw;
526. Terminal limit block;
527. Terminal limit connection plate;
528. Terminal insertion positioning seat;
529. Positioning buffer spring;
530. Guide slide block;
531. pressing sliding seat;
533. Upper positioning rod;
534. Auxiliary terminal clamping claw;
535. Terminal separation teeth;
536. Inter-terminal distance adjusting slot;
537. Terminal limit slot;
6. Second terminal feeding mechanism;
7. Defective product reclaiming device;
701. Defective product detection support;
702. Left and right sliding cylinder;
703. Left and right translation detection seat;
704. Front and rear sliding cylinder;
705. Front and rear translation detection seat;
706. Up and down sliding cylinder;
707. Detection connection plate;
708. Photoelectric sensor;
709. Defective product clamping claw;
710. Defective product clamping cylinder;
9. Jig assembly;
10. Terminal socket;
11. Jig base;
12. Lower positioning rod;
13. Socket positioning seat;

### 14. Jack;

15. Upper unloading jogging pole;
16. Terminal detection rod;

### 17. Terminal;

18. Curved part;
19. Restoring spring;
801. Terminal detection feed cylinder;
802. Terminal detection base;
803. Diffuse mode photoelectric switch
804. Displacement sensor.

### DETAILED DESCRIPTION OF THE ILLUSTRATED EMBODIMENT

The present invention will be described in detail below with reference to the accompanying drawings, and the description of the present invention is only exemplary and explanatory, and should not be construed as limiting the scope of the present invention.

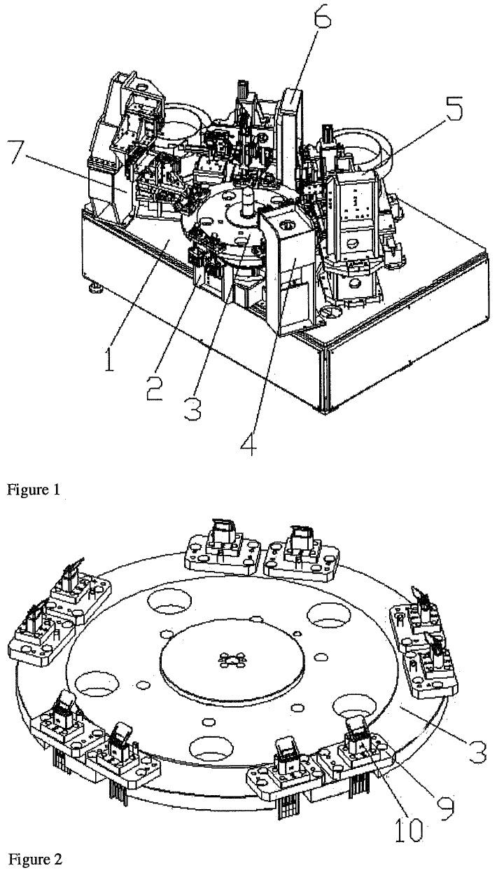

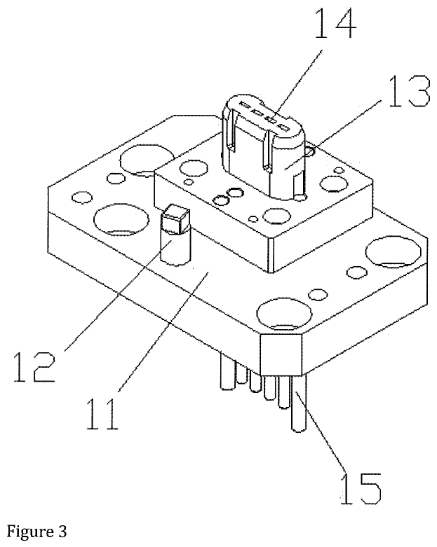

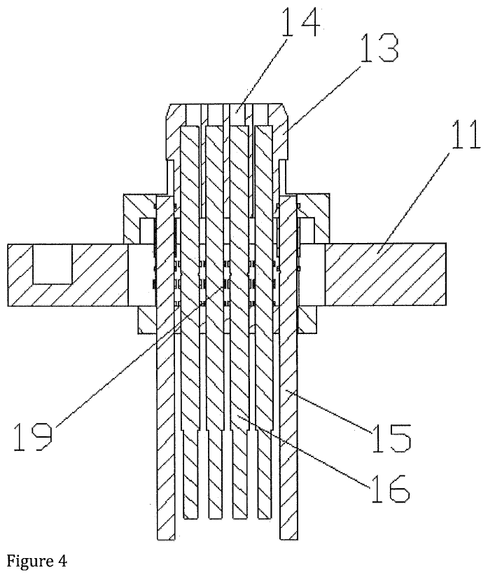

As shown in FIG. 1, a terminal with curved part assembly device, comprising a frame 1, power distribution control box, turntable 3 and turntable drive device disposed on the frame 1 and matching with each other, wherein the upper edge of the turntable 3 is evenly disposed with jig assemblies 9; the jig assembly 9 comprises a jig base 11 disposed on the edge of the turntable 3; the jig base 11 is provided with a socket positioning seat 13 which matches the terminal socket 10 by plugging and fitting; the socket positioning seat 13 is internally provided with jacks 14, which match terminals 17 in the terminal socket 10 by plugging; under the jig base 11 to the left and right side of the socket positioning seat 13 are provided the upper unloading jogging poles 15, and on the said upper unloading jogging poles 15 inside the jig base 11 are provided relocating springs 19; and inside the socket positioning seat 13 are plugged terminal detection rods 16 corresponding to the jacks 14, and on the terminal detection rods 16 inside the jig base 11 are sleeved the relocating springs 19; on the periphery of the turntable 3 and on the frame 1 is sequentially provided with a socket press-in device 4, a first terminal feeding mechanism 5, a second terminal feeding mechanism 6 and a defective product reclaiming device 7, cooperating with the jig assembly 9; the socket press-in device 4, the first terminal feeding mechanism 5, the second terminal feeding mechanism 6 and the defective product reclaiming device 7 are all electronically connected to the power distribution control box. The present invention provides an automatic terminal fitting device, which can be applied in the technical field of automatic assembly, is able to plug the terminals into the terminal socket quickly, precisely and stably, and achieve a high quality and efficiency assembly of the connectors.

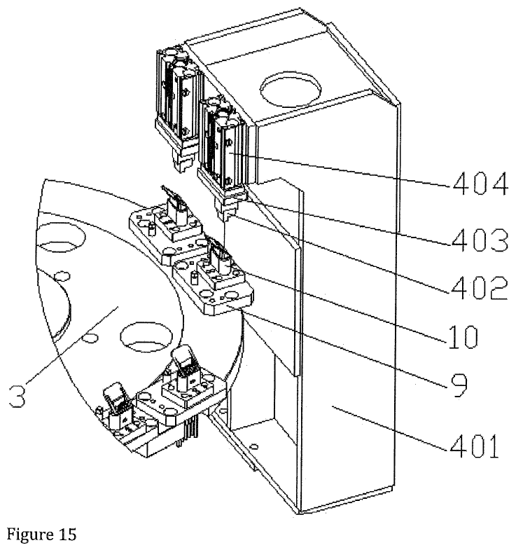

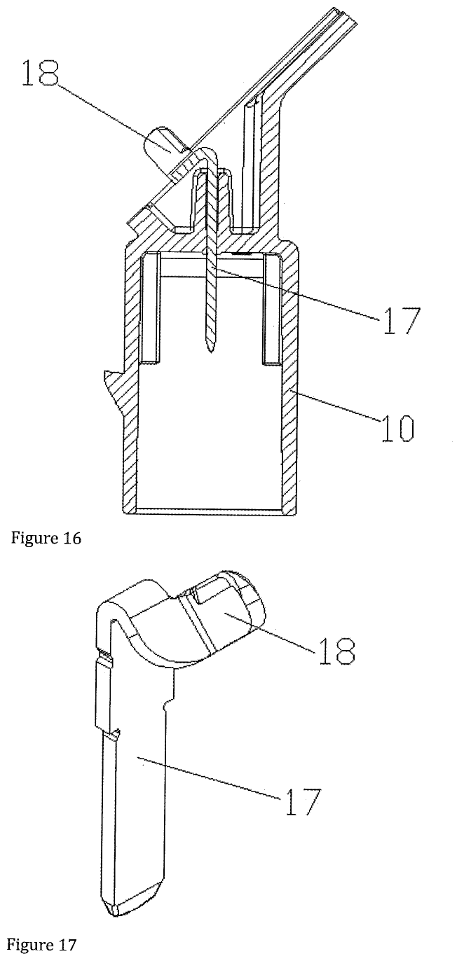

As shown in FIG. 15, the socket press-in device 4 includes a press-in support 401 disposed on the frame 1, pressing cylinders 404 are disposed vertically downward on the side of the support 401 adjacent to the turntable 3; the output of the pressing cylinders 404 is respectively connected to pressing plates 403, the lower ends of the pressing plates 403 are respectively connected with socket pressing heads 402 cooperating with the terminal socket 10; the pressing cylinder 404 is electrically connected to the power distribution control box. By pushing the terminal pressing head 402 down with the pressing cylinders 404, it is possible to fit the terminal socket 10 onto the socket positioning seat 13, and promise accuracy of terminal fitting.

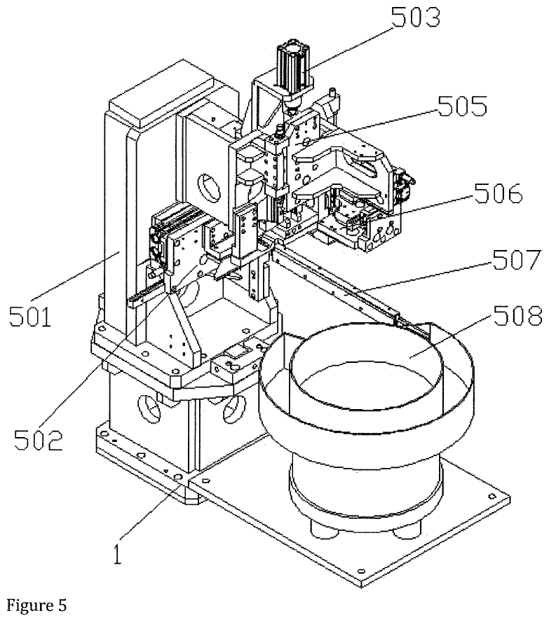

As shown in FIG. 5, both the first terminal feeding mechanism 5 and the second terminal feeding mechanism 6 include a terminal insertion support 501 and a terminal vibration feeding plate 508 disposed side by side on the frame 1, and a terminal conveying track 507 connected to the terminal vibration feeding plate 508; before terminal insertion support 501 is provided an inter-terminal distance adjusting device 502 cooperating with the terminal conveying track 507, the upper end of the terminal insertion support 501 is provided with a terminal insertion cylinder 503 vertically downward; the output of the terminal insertion cylinder 503 is connected with a terminal pressing connection plate 505 slidable against the terminal support 501; the terminal pressing connection plate 505 is provided with a terminal clamping device 506 located to the right side of the inter-terminal distance adjusting device 502, and the terminal clamping device 506 and the jig assembly 9 on the turntable 3 are vertically aligned. By feeding terminals to the inter-terminal distance adjusting device 502 with the terminal vibration feeding plate 508, where the distance between terminals is adjusted to be the same as that is required in the completed connectors, it is possible to promise the accurate plugging of the terminals, which is delicately designed and precisely positioned.

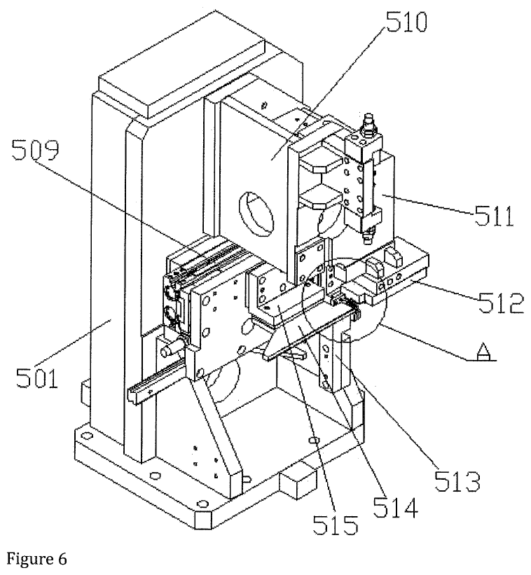

As shown in FIGS. 6 and 11, the inter-terminal distance adjusting device 502 includes an inter-terminal distance adjusting seat 511 disposed on the terminal insertion support 501; the lower end of the inter-terminal distance adjusting seat 511 is horizontally connected with an inter-terminal distance adjusting plate 512, and the bottom of the inter-terminal distance adjusting plate 512 is provided with inter-terminal distance adjusting slots 536 matching terminals 17 respectively; the distance between the inter-terminal distance adjusting slots 536 increases gradually and is finally the same as the distance between the terminal insertion holes in the product connector. By sliding the terminals 17 along the inter-terminal distance adjusting slots 536, the distance between terminals can be adjusted automatically, which is delicately designed and easy to operate.

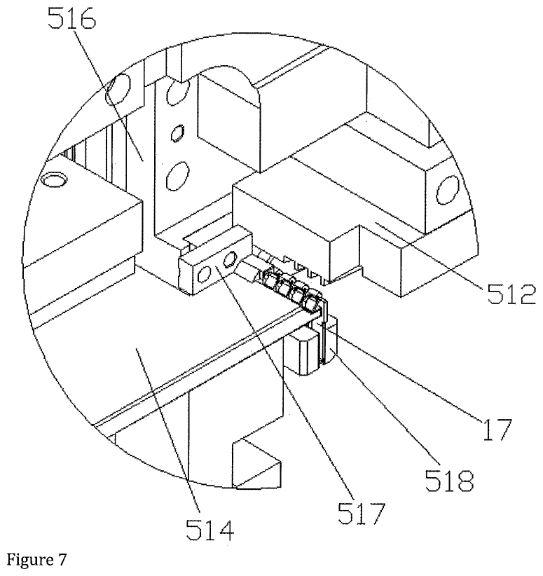

As shown in FIGS. 6 and 7, a terminal positioning cylinder 509 is horizontally disposed on the terminal support 501 and under the inter-terminal distance adjusting seat 511; the output of the terminal positioning cylinder 509 is connected with a terminal positioning sliding seat 515, and to the right end of the terminal positioning sliding seat 515 is provided a terminal guide cylinder 516 vertically downward; the output of the terminal guide cylinder 516 is connected with a terminal distribution block 518 cooperating with the terminal conveying track 507, the upper end of terminals 17 in the terminal distribution block 518 can be sliding against the inter-terminal distance adjusting slots 536; the middle of the terminal distribution block 518 is provided with distribution slots communicating with the terminal conveying track 507, a terminal guiding baffle plate 514 is horizontally disposed on the positioning sliding seat 515; the right end surface of the terminal guiding baffle plate 514 is located above the distribution slots and is butting with the terminal conveying track 507; to the rear side of the terminal guiding baffle plate 514 is provided a terminal positioning block 517 matching with the terminals 17. By moving the terminal positioning sliding seat 515 with the terminal positioning cylinder 509, and moving the terminal distribution block 518 with the terminal guide cylinder 516 along the bottom of the inter-terminal distance adjusting plate 512, the distance between terminals can be adjusted; in the meantime, with the terminal guiding baffle plate 514, it is possible to keep all 4 terminals in a row, and move simultaneously, while by stopping terminals inside with the terminal positioning block 517, terminals can be moving outwards to adjust distance therebetween, which improves accuracy of terminal positioning, and is of delicate design and easy operation.

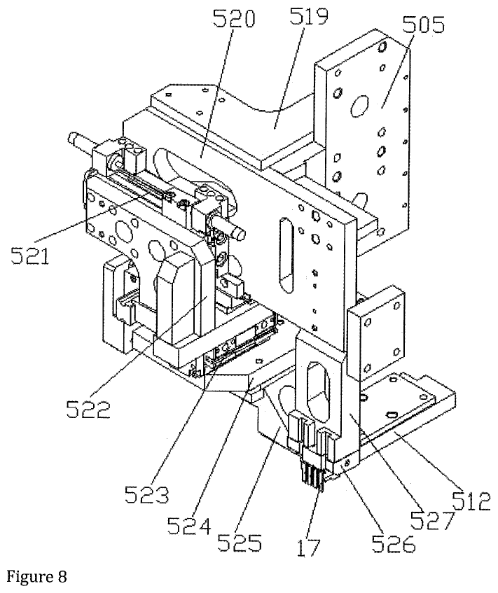

As shown in FIG. 8, the terminal clamping device 506 includes an L-shaped terminal clamping connection plate 519 connected to the front side of the terminal pressing connection plate 505; a clamping mounting seat 520 is connected to the terminal clamping connection plate 519, and the lower end of the clamping mounting seat 520 is vertically connected with a terminal limit connection plate 527; the lower end of the terminal limit connection plate 527 is provided with a terminal limit block 526 butting and matching with the inter-terminal distance adjusting plate 512, and the bottom of the terminal limit block 526 is provided with terminal limit slots 537 communicating with the inter-terminal distance adjusting slots 536; the right side of the clamping mounting seat 520 is provided with a limit feeding cylinder 521 along the front-rear direction, the output of the limit feeding cylinder 521 is connected with a limit feeding connection plate 522; the lower end of the limit feeding connection plate 522 is provided with a clamping feeding cylinder 523 along the left-right direction, the output of the clamping feeding cylinder 523 is connected with a clamping connection plate 524; a main terminal clamping claw 525 matching with the terminals 17 is mounted on the lower end of the clamping connection plate 524. With the design of the terminal limit block 526, accuracy of terminal positioning is further improved.

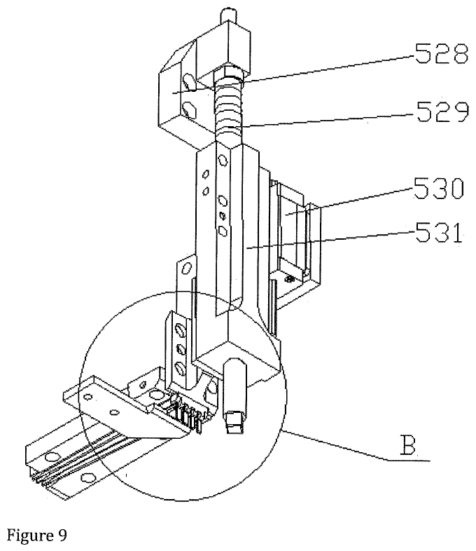

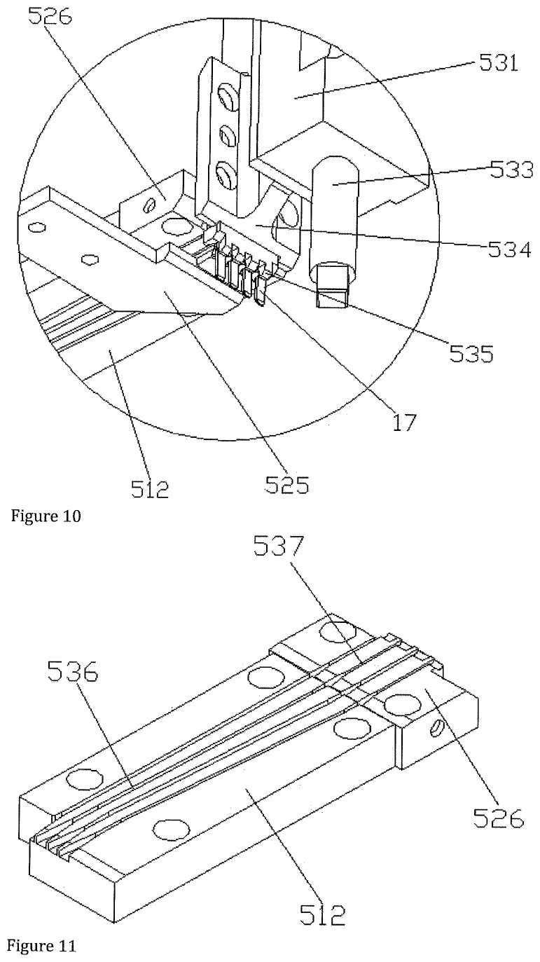

As shown in FIGS. 9 and 10, the right side of the clamping mounting seat 520 is provided with a press-down positioning device aligned vertically with the jig assembly 9; the press-down positioning device includes a terminal insertion positioning seat 528 disposed on the right side of the clamping mounting seat 520, an upper positioning rod 533 is sleeved vertically onto and can be sliding against the terminal insertion positioning seat 528, the lower end of the upper positioning rod 533 is aligned with the lower positioning rod 12 disposed on the jig base 11; and a pressing sliding seat 531 is sleeved on and can be sliding against the upper positioning rod 533, the pressing sliding seat 531 is slidably cooperating with a guide slide block 530 disposed on the clamping mounting seat 520; the upper positioning rod 533 is sleeved with a positioning buffer spring 529 above the pressing sliding seat 531; the left side of the pressing sliding seat 531 is mounted with an auxiliary terminal clamping claw 534 cooperating with the main terminal clamping claw 525, the lower end of the auxiliary terminal clamping claw 534 can be buckled with the main terminal clamping claw 525. By the cooperation of the main terminal clamping claw 525 and the auxiliary terminal clamping claw 534, it is possible to clamp the terminals tight, while the upper positioning rod 533 shall position the terminals, which ensures accuracy of terminal feeding position.

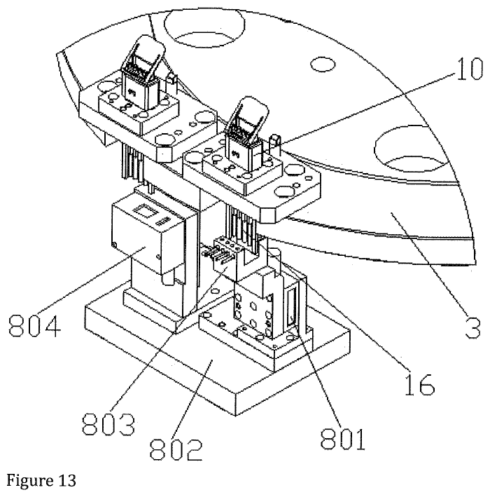

As shown in FIG. 13, a terminal lower end detection device matching with the terminal detection rods 16 is disposed below the terminal clamping device 506; the terminal lower end detection device includes a terminal detection base 802 disposed on the frame 1, a terminal detection feeding cylinder 801 is vertically upward provided on the terminal detection base 802; the output of the terminal detection feeding cylinder 801 is connected with a diffuse mode photoelectric switch 803 cooperating with the terminal detection rods 16 by plugging, the diffuse mode photoelectric switch 803 is electrically connected to the displacement sensor 804 disposed on the terminal detection base 802. By pushing the diffuse mode photoelectric switch 803 upwards with the terminal detection feeding cylinder 801, and checking whether the lower ends of all terminals appear to be flat, it is possible to know whether the inserting depth of all terminals are the same and ensure accuracy of terminal insertion.

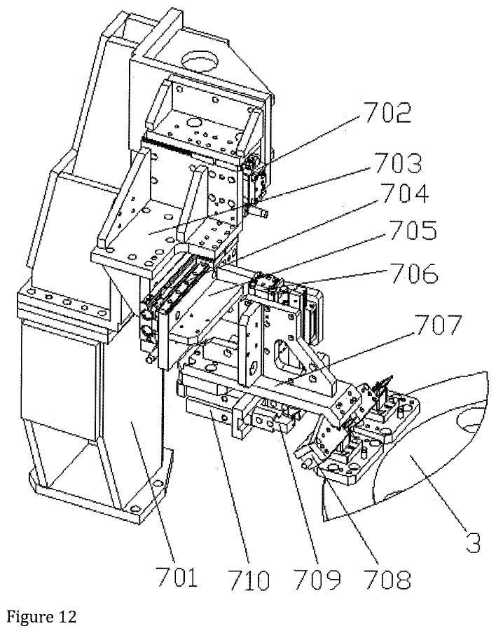

As shown in FIG. 12, the defective product reclaiming device 7 includes a defective product detection support 701 disposed on the frame 1; the upper end of the defective product detection support 701 is horizontally provided with a left and right sliding cylinder 702, the output of the left and right sliding cylinder 702 is connected with a left and right translation seat 703; the bottom of the left and right translation seat 703 is provided with a front and rear sliding cylinder 704, and the output of the front and rear sliding cylinder 704 is connected with a front and rear translation seat 705; an up and down sliding cylinder 706 is vertically downward provided on the front and rear translation seat 705, and the output of the up and down sliding cylinder 706 is horizontally connected with a detection connection plate 707; the right side of the detection connection plate 707 is provided with an photoelectric sensor 708 matching the upper ends of the terminals 17, and the left side thereof is provided with a defective product clamping cylinder 710; the output of the defective product clamping cylinder 710 is connected with a defective product clamping claw 709 matching the terminal socket 10. By the photoelectric sensor 708, it is possible to know whether upper ends of the terminals are flat, and check further the inserting depth of terminals, and with the defective product clamping claw 709, it is possible to remove the defective product and promise product quality.

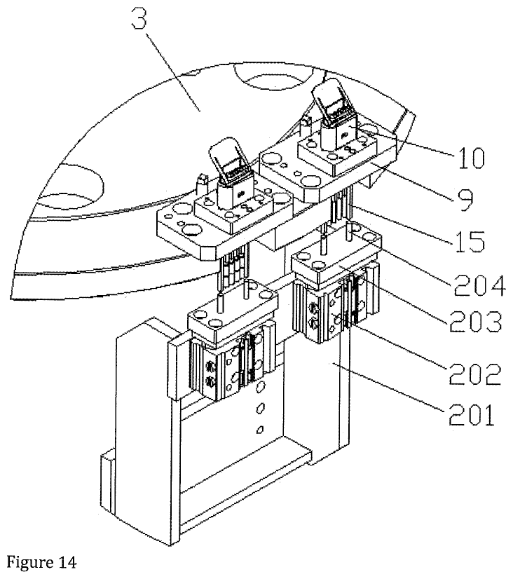

As shown in FIG. 14, an unloading device 2 matching the upper unloading jogging poles 15 is disposed between the defective product reclaiming device 7 and the socket press-in device 4; the unloading device 2 comprises an unloading support 201 provided on the frame 1, and the unloading support 201 is provided with an unloading cylinder 202 corresponding to the jig assembly 9; the output of the unloading cylinder 202 is connected with an unloading jogging plate 203, the upper surface of the unloading jogging plate 203 is vertically provided with a lower unloading jogging poles 204 butting and matching with the upper unloading jogging poles 15. By pushing the lower unloading jogging poles with the unloading cylinder 202, and pushing the upper unloading jogging poles 15, it is possible to have the terminal socket 10 pushed out of the socket positioning seat 13, and unload the product.

When in use, the terminal is first placed on the terminal vibration feeding plate 508, and the terminal socket 10 is placed on the jig assembly 9. The turntable 3 drives the jig assembly 9 below the socket press-in device 4, then the socket pressing head 402 is pushed down by the press-in cylinder 404 to fasten the terminal socket 10 to the socket positioning seat 13. The turntable 3 keeps rotating, and the jig assemblies 9 are sequentially sent to be under the first terminal feeding mechanism 5 and the second terminal feeding mechanism 6. Feed the terminals with the curved parts 18 in the upper side along the terminal conveying track 507 to the terminal distribution block 518, meanwhile, push the terminal positioning sliding seat 515 with the terminal positioning cylinder 509, so that the terminals are hung on one side of the terminal guiding baffle plate 514.

Then the terminal positioning cylinder 509 continues to push the terminal positioning sliding seat 515, so that the terminal guiding baffle plate 514 pushes the terminals to be sliding along the terminal adjusting slots 536 at the bottom of the inter-terminal distance adjusting plate 512. The terminal guiding baffle plate 514 may ensure that the four sets of terminals are kept in one row and the four sets of terminals are sliding simultaneously. At the same time, the terminal positioning block 517 blocks the inner terminals, so that the terminals slide to the outside to adjust the distance. The adjusted four sets of terminals are pushed into the terminal limit slots 537 in the bottom of the terminal limit block 526, then the terminal guide cylinder 516 pushes the terminal distribution block 518 downward, and the terminal positioning cylinder 509 drives terminal distribution block 518 back to butt with the terminal conveying track 507.

The limit feeding cylinder 521 pushes the limit feeding connection plate 522 to be close to the terminal limit block 526, meanwhile the clamping feeding cylinder 523 pushes the clamping main claw 524 to be close to the terminals, so that the terminal clamp main claw 524 and the terminal clamp accessory claw 534 are closed and clamping the lower ends of the terminals. Then the terminal insertion cylinder 503 moves downward, and locate the terminals with the upper positioning rod 533 to ensure the accuracy of the terminal feeding position. Finally, the terminals are inserted into the terminal socket 10, into the jacks 14. Meanwhile, press the terminal detection rod 16 downward, by pushing up the diffuse mode photoelectric switch 803 with the terminal detection feed cylinder 801 and detecting whether the lower ends of the terminal detection rods 16 are flush, it is possible to know whether the insertion depth of the terminals is uniform, and the precision of the terminal insertion is ensured. Then the turntable 3 continues to rotate the jig assembly 9 to under the defective product reclaiming device 7. The photoelectric sensor 708 can detect whether the upper ends of the terminals is flush, and detect the insertion depth of the terminal, meanwhile, the defective product is removed by the defective product clamping claw 709 to ensure the product quality. Then the turntable 3 continues to rotate the jig assembly 9 to the unloading part, The unloading cylinder 202 pushes up the lower unloading jogging poles 204 and then the upper unloading jogging poles 15, thereby the terminal socket 10 is pushed out of the socket positioning seat 13 to facilitate the unloading of the product.

It is to be understood that the term “includes”, “including” or any other variants thereof is intended to encompass a non-exclusive inclusion, such that a process, method, article, or device that comprises a plurality of elements includes not only those elements. It, also includes other elements that are not explicitly listed, or elements that are inherent to such a process, method, item, or device.

The principles and embodiments of the present invention have been described with reference to specific examples. The foregoing description of the embodiments is only for the purpose of understanding the method of the present invention and the core idea thereof. The above description is only a preferred embodiment of the present invention, and it should be noted that due to the finiteness of the textual expression and the infinitely specific structure objectively, it is possible for those skilled in the art to make some improvements, refinements or changes without departing from the principles of the present invention. The above technical features may be combined in an appropriate manner; these improvements, modifications, variations or combinations, or the direct application of the inventive concepts and technical solutions to other applications without modification, are considered to be the scope of protection of the present invention

What is claimed is:

1. A terminal with curved part assembly device, comprising a frame 1, power distribution control box, turntable 3 and turntable drive device disposed on the frame 1 and matching with each other, wherein the upper edge of the turntable 3 is evenly disposed with jig assemblies 9; the jig assembly 9 comprises a jig base 11 disposed on the edge of the turntable 3; the jig base 11 is provided with a socket positioning seat 13 which matches the terminal socket 10 by plugging and fitting; the socket positioning seat 13 is internally provided with jacks 14, which match terminals 17 in the terminal socket 10 by plugging; under the jig base 11 to the left and right side of the socket positioning seat 13 are provided the upper unloading jogging poles 15, and on the said upper unloading jogging poles 15 inside the jig base 11 are provided relocating springs 19; and inside the socket positioning seat 13 are plugged terminal detection rods 16 corresponding to the jacks 14, and on the terminal detection rods 16 inside the jig base 11 are sleeved the relocating springs 19;
on the periphery of the turntable 3 and on the frame 1 is sequentially provided with a socket press-in device 4, a first terminal feeding mechanism 5, a second terminal feeding mechanism 6 and a defective product reclaiming device 7, cooperating with the jig assembly 9; the socket press-in device 4, the first terminal feeding mechanism 5, the second terminal feeding mechanism 6 and the defective product reclaiming device 7 are all electronically connected to the power distribution control box.

2. The terminal with curved part assembly device of claim 1, wherein the socket press-in device 4 includes a press-in support 401 disposed on the frame 1, pressing cylinders 404 are disposed vertically downward on the side of the support 401 adjacent to the turntable 3; the output of the pressing cylinders 404 is respectively connected to pressing plates 403, the lower ends of the pressing plates 403 are respectively connected with socket pressing heads 402 cooperating with the terminal socket 10; the pressing cylinder 404 is electrically connected to the power distribution control box.

3. The terminal with curved part assembly device of claim 1, wherein both the first terminal feeding mechanism 5 and the second terminal feeding mechanism 6 include a terminal insertion support 501 and a terminal vibration feeding plate 508 disposed side by side on the frame 1, and a terminal conveying track 507 connected to the terminal vibration feeding plate 508; before terminal insertion support 501 is provided an inter-terminal distance adjusting device 502 cooperating with the terminal conveying track 507, the upper end of the terminal insertion support 501 is provided with a terminal insertion cylinder 503 vertically downward; the output of the terminal insertion cylinder 503 is connected with a terminal pressing connection plate 505 slidable against the terminal support 501; the terminal pressing connection plate 505 is provided with a terminal clamping device 506 located to the right side of the inter-terminal distance adjusting device 502, and the terminal clamping device 506 and the jig assembly 9 on the turntable 3 are vertically aligned.

4. The terminal with curved part assembly device of claim 3, wherein the inter-terminal distance adjusting device 502 includes an inter-terminal distance adjusting seat 511 disposed on the terminal insertion support 501;
the lower end of the inter-terminal distance adjusting seat 511 is horizontally connected with an inter-terminal distance adjusting plate 512, and the bottom of the inter-terminal distance adjusting plate 512 is provided with inter-terminal distance adjusting slots 536 matching terminals 17 respectively; the distance between the inter-terminal distance adjusting slots 536 increases gradually and is finally the same as the distance between the terminal insertion holes in the product connector.

5. The terminal with curved part assembly device of claim 4, wherein a terminal positioning cylinder 509 is horizontally disposed on the terminal support 501 and under the inter-terminal distance adjusting seat 511; the output of the terminal positioning cylinder 509 is connected with a terminal positioning sliding seat 515, and to the right end of the terminal positioning sliding seat 515 is provided a terminal guide cylinder 516 vertically downward;
the output of the terminal guide cylinder 516 is connected with a terminal distribution block 518 cooperating with the terminal conveying track 507, the upper end of terminals 17 in the terminal distribution block 518 can be sliding against the inter-terminal distance adjusting slots 536; the middle of the terminal distribution block 518 is provided with distribution slots communicating with the terminal conveying track 507, a terminal guiding baffle plate 514 is horizontally disposed on the positioning sliding seat 515;
the right end surface of the terminal guiding baffle plate 514 is located above the distribution slots and is butting with the terminal conveying track 507; to the rear side of the terminal guiding baffle plate 514 is provided a terminal positioning block 517 matching with the terminals 17.

6. The terminal with curved part assembly device of claim 4, wherein the terminal clamping device 506 includes an L-shaped terminal clamping connection plate 519 connected to the front side of the terminal pressing connection plate 505; a clamping mounting seat 520 is connected to the terminal clamping connection plate 519, and the lower end of the clamping mounting seat 520 is vertically connected with a terminal limit connection plate 527; the lower end of the terminal limit connection plate 527 is provided with a terminal limit block 526 butting and matching with the inter-terminal distance adjusting plate 512, and the bottom of the terminal limit block 526 is provided with terminal limit slots 537 communicating with the inter-terminal distance adjusting slots 536; the right side of the clamping mounting seat 520 is provided with a limit feeding cylinder 521 along the front-rear direction, the output of the limit feeding cylinder 521 is connected with a limit feeding connection plate 522; the lower end of the limit feeding connection plate 522 is provided with a clamping feeding cylinder 523 along the left-right direction, the output of the clamping feeding cylinder 523 is connected with a clamping connection plate 524; a main terminal clamping claw 525 matching with the terminals 17 is mounted on the lower end of the clamping connection plate 524.

7. The terminal with curved part assembly device of claim 5, wherein the right side of the clamping mounting seat 520 is provided with a press-down positioning device aligned vertically with the jig assembly 9; the press-down positioning device includes a terminal insertion positioning seat 528 disposed on the right side of the clamping mounting seat 520, an upper positioning rod 533 is sleeved vertically onto and can be sliding against the terminal insertion positioning seat 528, the lower end of the upper positioning rod 533 is aligned with the lower positioning rod 12 disposed on the jig base 11; and a pressing sliding seat 531 is sleeved on and can be sliding against the upper positioning rod 533, the pressing sliding seat 531 is slidably cooperating with a guide slide block 530 disposed on the clamping mounting seat 520; the upper positioning rod 533 is sleeved with a positioning buffer spring 529 above the pressing sliding seat 531; the left side of the pressing sliding seat 531 is mounted with an auxiliary terminal clamping claw 534 cooperating with the main terminal clamping claw 525, the lower end of the auxiliary terminal clamping claw 534 can be buckled with the main terminal clamping claw 525.

8. The terminal with curved part assembly device of claim 6, wherein a terminal lower end detection device matching with the terminal detection rods 16 is disposed below the terminal clamping device 506; the terminal lower end detection device includes a terminal detection base 802 disposed on the frame 1, a terminal detection feeding cylinder 801 is vertically upward provided on the terminal detection base 802; the output of the terminal detection feeding cylinder 801 is connected with a diffuse mode photoelectric switch 803 cooperating with the terminal detection rods 16 by plugging, the diffuse mode photoelectric switch 803 is electronically connected to the displacement sensor 804 disposed on the terminal detection base 802.

9. The terminal with curved part assembly device of claim 1, wherein the defective product reclaiming device 7 includes a defective product detection support 701 disposed on the frame 1; the upper end of the defective product detection support 701 is horizontally provided with a left and right sliding cylinder 702, the output of the left and right sliding cylinder 702 is connected with a left and right translation seat 703; the bottom of the left and right translation seat 703 is provided with a front and rear sliding cylinder 704, and the output of the front and rear sliding cylinder 704 is connected with a front and rear translation seat 705; an up and down sliding cylinder 706 is vertically downward provided on the front and rear translation seat 705, and the output of the up and down sliding cylinder 706 is horizontally connected with a detection connection plate 707; the right side of the detection connection plate 707 is provided with an photoelectric sensor 708 matching the upper ends of the terminals 17, and the left side thereof is provided with a defective product clamping cylinder 710; the output of the defective product clamping cylinder 710 is connected with a defective product clamping claw 709 matching the terminal socket 10.

10. The terminal with curved part assembly device of claim 1, wherein an unloading device 2 matching the upper unloading jogging poles 15 is disposed between the defective product reclaiming device 7 and the socket press-in device 4; the unloading device 2 comprises an unloading support 201 provided on the frame 1, and the unloading support 201 is provided with an unloading cylinder 202 corresponding to the jig assembly 9; the output of the unloading cylinder 202 is connected with an unloading jogging plate 203, the upper surface of the unloading jogging plate 203 is vertically provided with a lower unloading jogging poles 204 butting and matching with the upper unloading jogging poles 15.
